(19) United States
(12) Patent Application Publication
(10) Pub. No.: US 2025/0245137 A1
(43) Pub. Date: Jul. 31, 2025

(54) GAME TESTING TECHNIQUES USING MACHINE LEARNING

(71) Applicant: Electronic Arts Inc., Redwood City, CA (US)

(72) Inventor: WILLIAM ARTHUR GORDON, APOPKA, FL (US)

(21) Appl. No.: 18/423,877

(22) Filed: Jan. 26, 2024

(51) Int. Cl. G06F 11/36

(52) U.S. Cl. CPC G06F 11/3696

(57) ABSTRACT

A gaming device may provide for. The gaming device may receive video game execution data of a video game including data generated by instrumented code of the video game during execution of the video game, a rendered output of the video game during the execution of the video game, and telemetry data of the video game generated during the execution of the video game. The gaming device may then configure a ML model to at least one of detect or predict a type of events in the execution of the video game using at least the data generated by instrumented code, the rendered output of the video game, and the telemetry data as training data for the ML model.

### BACKGROUND

Video gaming allows for players to play a variety of electronic and/or video games. Video games have become increasingly complex and may include many thousands of states, interactions and scenarios. The complexity may complicate efforts to identify and fix bugs, performance issues and other problems.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with gaming system(s) that may provide for detecting and/or predicting of various events in execution of a computer program or application, in accordance with example embodiments of the disclosure.

FIG. 2 illustrates a schematic diagram of an example environment including a game client device with functionality that may provide for detecting and/or predicting of various events in execution of the video game, in accordance with example embodiments of the disclosure.

FIG. 3 illustrates an example view of a virtual environment in which event detection and/or prediction may be performed based on video game execution data, in accordance with example embodiments of the disclosure.

FIG. 4 illustrates a flow diagram of an example method that may train a ML model to detect and/or predict various events in execution of a computer program, in accordance with example embodiments of the disclosure.

FIG. 5 illustrates a flow diagram of an example method that may provide for detection or prediction of events in execution of a computer program, in accordance with example embodiments of the disclosure.

FIG. 6 illustrates a block diagram of example game client device(s) that may provide for detecting and/or predicting of various events in execution of a computer program or application, in accordance with example embodiments of the disclosure.

### DETAILED DESCRIPTION

Example embodiments of this disclosure describe methods, apparatuses, computer-readable media, and system(s) for providing detection and/or prediction of various events in execution of a computer program or application such as bugs, performance issues and so on. For example, systems and techniques according to this disclosure may detect events in stored video game execution data or live video game execution data.

Some examples may provide data regarding the detected events and/or other information to a user. In some examples, the systems and techniques according to this disclosure may be configured to detect events in logged video game execution data and output information regarding detected events in response to a user request. In addition or alternatively, the systems and techniques according to this disclosure may be configured to detect events and output information regarding detected events as video game execution data is received.

Further, systems and techniques according to this disclosure may be configured to predict the occurrence of events in video game execution. In some examples, the systems and techniques may output information regarding the predicted event and/or operate to change one or more settings of the video game to avoid or reduce an impact of the detected event on gameplay.

Some examples may train and utilize a machine learned (ML) model, such as a generative ML model, to detect and/or predict the occurrence of events in video game execution. As used herein, unless otherwise stated, references to a ML model or ML models may include one or more ML models. Some examples may utilize text data generated by instrumented code of the video game in combination with rendered outputs of the video game (e.g. video, image, etc.) and/or other telemetry data as input to the ML model. The inputs to the ML model may further include information to allow for the various inputs to be associated temporally (e.g., such that rendered outputs of the video game and textual data generated by the instrumented code at the same time are associated).

As used herein, instrumented code may refer to video game code that includes statements or commands for print debugging, logging, tracing or similar methods. Such instrumented code may generate textual data which may be output to a debugging console, printed to a screen, output to a log file and so on. The textual data may refer to textual data which may indicate where the program execution is in the video game code, code execution paths taken to reach a current state, state data of the video game (e.g., values of some inputs, outputs, intermediate variables, etc.) and so on. Such textual data may represent a record of events and video game program behavior that occurred while the program was running (e.g., at the time the textual data was generated and stored or in the current live execution of the video game).

The rendered outputs of video game may include video data, image data, audio data, tactile feedback data, and/or other outputs. For example, the rendered outputs may include the gameplay video of the video game. In some examples, the gameplay video of the video game may include additional information as an overlay of the rendered video. For example, the rendered video may include telemetry data such as a frame rate, a central processing unit (CPU) processing load, a graphics processing unit (GPU) processing load, a storage input/output (I/O) load, a networking load, a build number of the video game, a change list and so on. Additionally or alternatively, the telemetry data may be input to the machine learned model separately from the rendered output of the video game (e.g., as separate text or numeric data).

The machine learned model may receive the temporally associated inputs during training. Using such data, the machine learned model may be configured or trained to detect or predict the occurrence of types of events based on, for example, the portions of the game code being executed, state information included in the text data generated by the instrumented code, the rendered output(s), and/or the telemetry data. In an example, data associated with events of a particular type of event may be input to the ML model as examples of occurrences of that type of event (e.g., supervised learning). In addition or alternatively, the ML model may recognize or learn the types of events based on the telemetry data and/or text data generated by the instrumented code (e.g., unsupervised learning based on semantic meaning of the textual data).

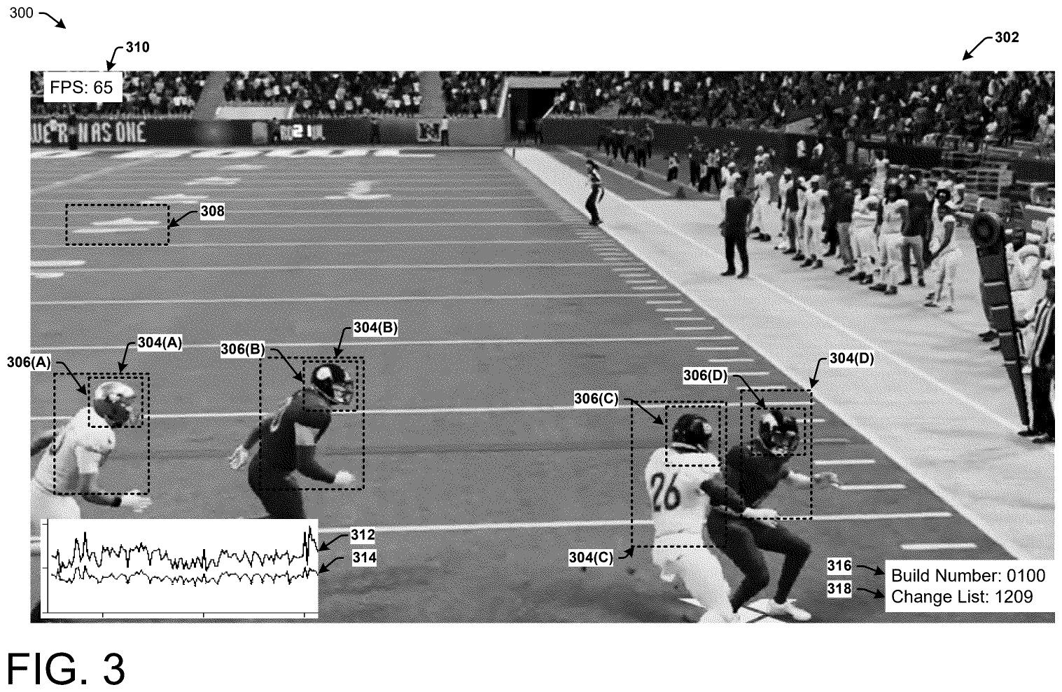

For example, the ML model may learn to associate rendered video frames from a sports video games along with the video game generated textual data to recognize events in the gameplay. For example, in a football video game, a frame rate drop event may occur as a result of the GPU processing load rapidly increasing in specific scenarios that occur during gameplay. As discussed in more detail with respect to the example shown in FIG. 3, different stadiums, weather patterns, ball positions, team matchups or special games may present different scenarios with different loads and execution paths. In some examples, the video game may render the video outputs of, for example, a football game being played by a user which may visually include telemetry data. For example, the video game may be configured to render the frame rate on screen. Alternatively or additionally, some or all of the telemetry data may be output separately (e.g., as text data) and associated temporally with the video output in a similar manner to the text data that generated by the instrumented code of the video game. The ML model may receive the temporally associated inputs during training to learn to associate various scenarios in the input data with the GPU processing loads. Of course, this is merely an example of a type of event and one of ordinary skill in art would understand other types of events that could be detected in view of this disclosure.

Further, as mentioned above, the ML model may be trained or be configured to predict types of events during live gameplay before the event occurs. For example, the ML model may receive inputs including textual data, telemetry data and results of visual analysis of the rendered video at a point in gameplay of the football game when a next play will be starting from a position far from the end zone (e.g., 70 yards), the weather for the game is snow, and the lighting conditions will cast complex shadows (e.g., the sun position causes more complex shadow patterns than other scenarios). The ML model may have been trained with prior scenarios with these and/or other characteristics and in which the frame rate in the scenario for the next play dropped and/or the GPU processing load jumped such that performance dropped such that a gameplay experience of a player would be impacted negatively. As such, the ML model may infer that the video game is going into a “high GPU stress” situation based on the inputs. In such a case, the ML model may provide an output of the prediction of the event. The prediction of the event may be utilized by a control system to determine a setting change for the game engine to avoid or ameliorate the predicted event. For example, a control system may change the rendering settings to lower a shadow quality, lower a detail level of weather, or lower a level of detail (LOD) setting for the video game based on an output of the ML model. Alternatively or additionally, the ML model may be configured to output a control to change the rendering settings to lower a shadow quality, lower a detail level of weather, or lower a LOD setting for the video game instead of, or in addition to, outputting the prediction of the event.

Further, the ML model may be utilized to detect or predict the occurrence of events for fewer inputs than utilized in training. For example, the ML model may be trained using textual data from instrumented code, results of visual analysis of the rendered video which may include some telemetry data, and/or telemetry data separate from the rendered video. In some examples, the ML model may be utilized to detect or predict the occurrence of events in the video game during an execution of a version or configuration of the video game that does not produce textual data from the instrumented code or include telemetry data in the rendered video. For example, in the above scenario, the ML model may infer the video game is going into a “high GPU stress” situation based on rendered video that shows a next play in the video game will be starting from a position far from the end zone, the weather for the game is snowing, and the lighting conditions will cast complex shadows even without one or more of the textual data generated by the instrumented code and/or telemetry data.

Some examples may include a large language model (LLM) or similar type of ML model. In some examples, the large language model may be used to produce reports or respond to natural language queries from a user. For example, the LLM may allow for a user to request a report for scenarios in a collection of video game execution data during which the video game experienced high GPU stress. Similarly, the LLM may allow for a user to request an alert when the video game is experiencing or is likely to soon experience high GPU stress during video game execution.

Further, an ML model according to this disclosure may be utilized to guide testing of a video game. As discussed above, the ML model may be trained to detect GPU stress from textual data from instrumented code, results of visual analysis of the rendered video which may include some telemetry data, and/or telemetry data separate from the rendered video. The ML model may be configured to predict other scenarios which may be tested to determine if similar GPU stress levels are experienced. Further, a developer may request the ML model generate a set of testing scenarios which may test a different aspect of the video game execution while excluding scenarios that would also cause high GPU stress. For example, the ML model may receive a request for and generate a set of testing scenarios which would test the video game for high input/output (I/O) stress without high rendering stress (e.g., where high levels of storage I/O may cause performance to suffer without simultaneous GPU stress). Additionally or alternatively, the ML model may receive a request for and generate a set of testing scenarios which would test the video game for multiple event types simultaneously (e.g., high input/output (I/O) stress, high GPU stress and/or additional types of events) to test performance of the video game for “worst case” scenarios. These and other examples are discussed in more detail below.

While the examples discussed herein relate to determining events in video game execution such as high GPU stress, low free memory, high I/O stress, network congestion, based on textual data from instrumented code, results of visual analysis of the rendered outputs which may include some telemetry data, and/or telemetry data separate from the rendered outputs, this is merely for ease of explanation in illustration and not intended as a limitation. Other examples may include additional or alternative types of events, input data and/or be utilized with computer programs or applications other than video games. For instance, ML model(s) may infer events based on feedback to an application via the operating system of the host platform. For example, a mobile phone platform may have many different sensors that could give feedback to the application or the testing system. For example, when a user tilts their mobile phone, the input to an application may lag or be lost. Some examples may detect the change in angle of the mobile phone and lag or loss of input data occurring shortly thereafter. In turn, a ML model may determine the tilting of the phone is related to the input lag or failure. In another example, the ML model may detect and/or predict a pattern in GPU usage load frequency (e.g., idle times) in association with an issues or bugs. Other examples may include additional or alternative types of telemetry data from those discussed herein such as an identifier of the hardware or console type of the game device. Other example types of telemetry data may include: shaped electronic signals; numerical counter displays; rendered shapes, colors, and objects; sequential flashing patterns of one or more pixels; optical light pulses; sound waves; radiated energy waveforms (e.g., UV, microwave, etc.); thermal energy patterns or pulses; inductive energy patterns or pulses; haptic, gyroscope, or physical force patterns; and so on. Further, while examples herein relate to using rendered video as a rendered output, examples are not so limited. For example, audio data may be utilized as rendered output. For instance, a stutter in the audio data may be indicative of high CPU stress or load in a similar manner to a frame rate drop in rendered video.

The techniques described herein for can improve a functioning of a computing device by providing for detecting and/or predicting of various events in execution of a computer program or application. For example, the techniques described herein may allow for the detection or prediction of an event affecting the functioning of the computer program to allow for the associated program code to be modified to prevent and/or ameliorate the event, allow for changes to the settings for the computer program to prevent and/or ameliorate the event and/or provide an indication of the occurrence or predicted occurrence of the event to a user. Further, the techniques described herein may provide for reducing a number of and/or improving selection of test cases for testing, enabling testing resources and developers to better focus on improving the computer program functionality. These and other improvements to the functioning of the computer are discussed herein.

Certain implementations and embodiments of the disclosure will now be described more fully below with reference to the accompanying figures, in which various aspects are shown. However, the various aspects may be implemented in many different forms and should not be construed as limited to the implementations set forth herein. For example, some examples provided herein relate to sport, fighting or shooting games. Implementations are not limited to the example genres. It will be appreciated that the disclosure encompasses variations of the embodiments, as described herein. Like numbers refer to like elements throughout.

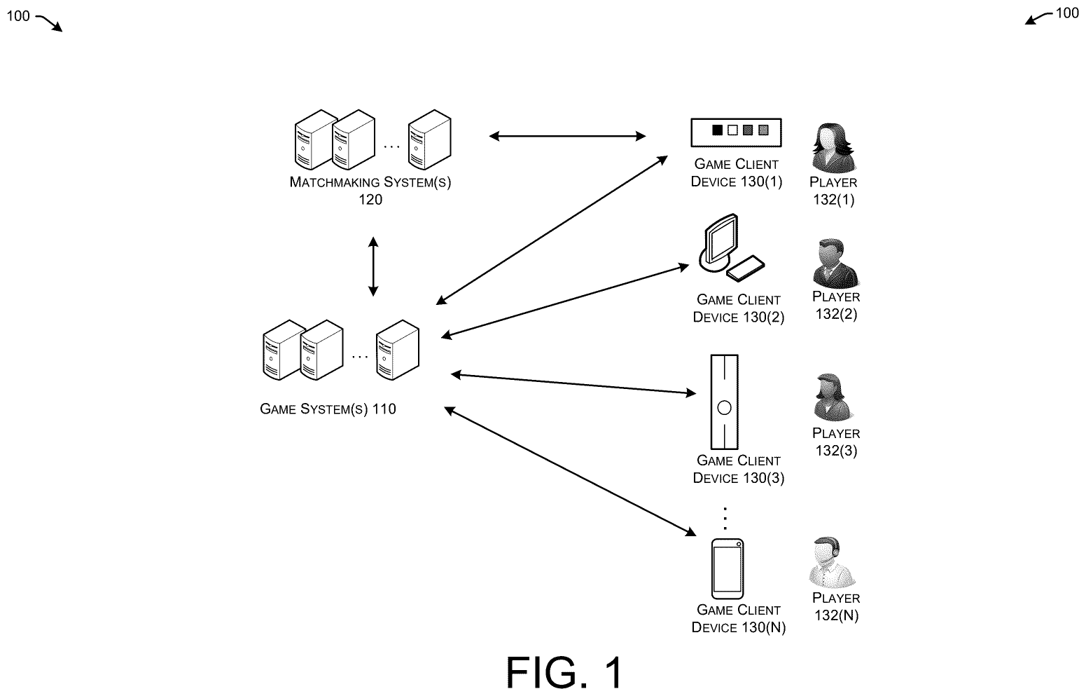

FIG. 1 illustrates a schematic diagram of an example environment 100 with game system(s) 110, matchmaking system(s) 120, and game client device(s) 130 that may provide for detecting and/or predicting of various events in execution of a computer program or application, in accordance with example embodiments of the disclosure.

The example environment 100 may include one or more player(s) 132(1), 132(2), 132(3), . . . 132(N), hereinafter referred to individually or collectively as player(s) 132, who may interact with respective game client device(s) 130(1), 130(2), 130(3), . . . 130(N), hereinafter referred to individually or collectively as game client device(s) 130 via respective input device(s). It should be understood that, as used herein, a player can refer to (i) a person playing or participating in a video game; (ii) systems or devices corresponding to, associated with, operated by and/or managed by a player; and/or (iii) accounts and/or other data or collections of data associated with or corresponding to a player.

The game client device(s) 130 may receive game state information from the one or more game system(s) 110 that may host the online game played by the player(s) 132 of environment 100. The game state information may be received repeatedly and/or continuously and/or as events of the online game transpire. The game state information may be based at least in part on the interactions that each of the player(s) 132 have in response to events of the online game hosted by the game system(s) 110.

The game client device(s) 130 may be configured to render content associated with the online game to respective player(s) 132 based at least on the game state information. More particularly, the game client device(s) 130 may use the most recent game state information to render current events of the online game as content. This content may include video, audio, haptic, combinations thereof, or the like content components.

As events transpire in the online game, the game system(s) 110 may update game state information and send that game state information to the game client device(s) 130. For example, if the player(s) 132 are playing an online soccer game, and the player 132 playing one of the goalies moves in a particular direction, then that movement and/or goalie location may be represented in the game state information that may be sent to each of the game client device(s) 130 for rendering the event of the goalie moving in the particular direction. In this way, the content of the online game is repeatedly updated throughout game play. Further, the game state information sent to individual game client device(s) 130 may be a subset or derivative of the full game state maintained at the game system(s) 110. For example, in a team deathmatch game, the game state information provided to a game client device 130 of a player may be a subset or derivative of the full game state generated based on the location of the player in the game simulation.

When the game client device(s) 130 receive the game state information from the game system(s) 110, a game client device 130 may render updated content associated with the online game to its respective player 132. This updated content may embody events that may have transpired since the previous state of the game (e.g., the movement of the goalie).

The game client device(s) 130 may accept input from respective player(s) 132 via respective input device(s). The input from the player(s) 132 may be responsive to events in the online game. For example, in an online basketball game, if a player 132 sees an event in the rendered content, such as an opposing team's guard blocking the point, the player 132 may use his/her input device to try to shoot a three-pointer. The intended action by the player 132, as captured via his/her input device, may be received by the game client device 130 and sent to the game system(s) 110.

The game client device(s) 130 may be any suitable device, including, but not limited to a Sony Playstation® line of systems, a Nintendo Switch® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, augmented reality (AR) or virtual reality (VR) systems (e.g., AR or VR headsets), combinations thereof, or the like. In general, the game client device(s) 130 may execute programs thereon to interact with the game system(s) 110 and render game content based at least in part on game state information received from the game system(s) 110. Additionally, the game client device(s) 130 may send indications of player input to the game system(s) 110. Game state information and player input information may be shared between the game client device(s) 130 and the game system(s) 110 using any suitable mechanism, such as application program interfaces (APIs).

The game system(s) 110 may receive inputs from various player(s) 132 and update the state of the online game based thereon. As discussed in more detail herein, the game system(s) 110 may operate to determine actions for one or more NPCs or computer controlled players and include those actions in the update of the state of the online game. As the state of the online game is updated, the state may be sent to the game client device(s) 130 for rendering online game content to player(s) 132. In this way, the game system(s) 110 may host the online game.

The example environment 100 may further include matchmaking system(s) 120 to match player(s) 132 who wish to play the same game and/or game mode with each other and to provide a platform for communication between the player(s) 132 playing online games (e.g., the same game and/or different games). The matchmaking system(s) 120 may receive an indication from the game system(s) 110 of player(s) 132 who wish to play an online game.

The matchmaking system(s) 120 may attempt matchmaking between player(s) 132. The matchmaking system(s) 120 may access information about the player(s) 132 who wish to play a particular online game, such as from a player datastore. A user account for each of the player(s) 132 may associate various information about the respective player(s) 132 and may be stored in the player datastore and accessed by the matchmaking system(s) 120.

Player(s) 132 may be matched according to one or more metrics associated with the player(s) 132 such as skill at a particular game. In addition to or alternatively to skill scores, player(s) 132 may be matched on a variety of other factors. Some example matchmaking factors may be related to behavior in addition to skill and may include a player's playstyle.

Having matched the player(s) 132, the matchmaking system(s) 120 may instruct generation of instance(s) of the online game(s) for the match(es). More particularly, the matchmaking system(s) 120 may request the game system(s) 110 instantiate an online game between the matched player(s) 132. For example, the matchmaking system(s) 120 may provide connection information for the game client device(s) 130 to the game system(s) 110 for instantiation of an instance of the online game between the matched player(s) 132.

The game system(s) 110 and or game client device(s) 130 may further include functionality to provide for detecting and/or predicting of various events in execution of the video game. The following discussion relates to an example in which functionality for detecting and/or predicting of various events in execution is performed for the game client(s) of the game client device(s) 130. However, examples are not so limited. For example, other examples may include the game system 130 or a different system receiving textual data from instrumented code of the game client, the rendered outputs which may include some telemetry data, telemetry data separate from the rendered outputs and so on and performing the event detection and/or prediction functionality and either providing the result or controls based thereon to the game client device(s) 130 and/or the game system(s) 110. Moreover, some examples of this disclosure may include local game play and other variations.

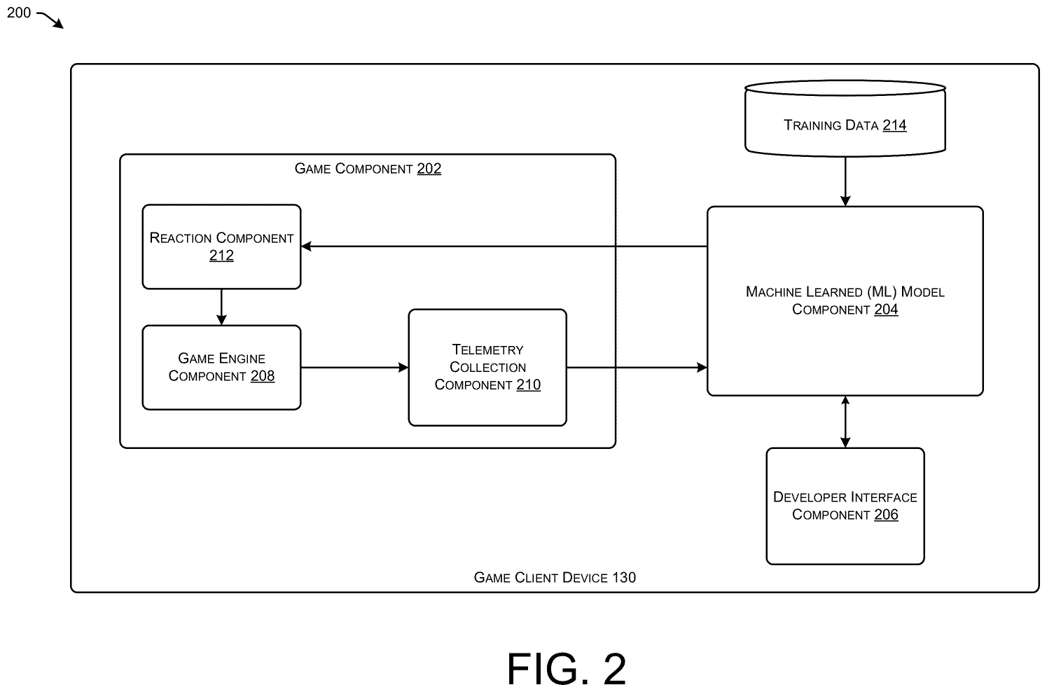

FIG. 2 illustrates a schematic diagram of an example environment 200 including a game client device with functionality that may provide for detecting and/or predicting of various events in execution of the video game. As illustrated, the game client device 130 may include a game component 202, a machine learned (ML) model component 204, a developer interface component 206 and a training data store storing training data 214. The game component 202 may include a game engine component 208, a telemetry collection component 210, and a reaction component 212.

Generally, the game engine component 208 of the game component 202 may operate to perform the rendering, networking and input/output functionality of the game client device 130 discussed above with respect to FIG. 1. For example, the game engine component 208 may include the video game program code to interact with the game system(s) 110, render game content based at least in part on game state information received from the game system(s) 110, receive and send indications of player input to the game system(s) 110 and so on. Additionally or alternatively, the game engine component 208 may perform the operations of the game system 110 discussed above for maintaining and controlling the state of the video game in local game play variations (e.g., during single player or local multiplayer scenarios).

In operation, the ML model component 204 may be configured to receive training data 214. For example, the ML model component 204 may be configured to receive the training data 214 during a training mode to configure the ML model component 204 to detect and/or predict the occurrence of events in video game execution of the game engine component 208. As discussed above, the training data 214 may include text data generated by instrumented code of the video game in combination with rendered outputs of the game engine component 208 (e.g. video, image, etc.) and/or other telemetry data as input to the ML model. The training data 214 may further include information to allow for the various inputs to be associated temporally (e.g., such that rendered outputs of the video game and textual data generated by the instrumented code at the same time are associated).

As discussed above, instrumented code may refer to video game code of the game engine component 208 that includes statements or commands for print debugging, logging, tracing or similar methods. Such instrumented code may generate textual data which may be output to a debugging console, printed to a screen, output to a log file and so on. The textual data may indicate where the program execution is in the video game code, execution paths, state data of the video game (e.g., values of some inputs, outputs, intermediate variables, etc.). Such textual data may represent a record of events and video game program behavior that occurred while the program was running.

The rendered outputs of the game engine component 208 may include video data, image data, audio data, tactile feedback data, and/or other outputs. For example, the rendered outputs may include the gameplay video of the game engine component 208. In some examples, the gameplay video of the game engine component 208 may include additional information as an overlay on the rendered video. For example, the rendered video may include an overlay of telemetry data such as a frame rate, processing load, a build number of the video game, a change list and so on. Additionally or alternatively, the telemetry data may be input to the ML model component 204 separately from the rendered output of the game engine component 208 (e.g., as separate text or numeric data).

Based on the training data 214, the ML model component may be configured or trained to detect or predict the occurrence of types of events based on, for example, the portions of the game code being executed, state information included in the text data generated by the instrumented code, the rendered output(s), and/or the telemetry data. In an example, the training data 214 may include data associated with events of a particular type of event which may be input to the ML model component 204 as examples of that type of event (e.g., supervised learning). In addition or alternatively, the ML model component 204 may recognize or learn the types of events based on the telemetry data and/or text data generated by the instrumented code (e.g., unsupervised learning based on semantic meaning of the textual data).

The trained ML model component 204 may interact with the game component 202 and the developer interface component 206 based on stored video game execution data or live video game execution data to detect or predict the occurrence of the different types of events in video game execution of the game engine component 208 based on similar inputs to the training data 214. More particularly, during video game execution, the game engine component 208 may provide an output to the telemetry collection component 210 of one or more types of data. As discussed above, such data may include text data generated by instrumented code of the game engine component 208 in combination with rendered outputs of the game engine component 208 (e.g. video, image, etc.) and/or other telemetry data.

The telemetry collection component 210 may receive the video game execution data from game engine component 208. The telemetry collection component 210 may temporally associate various types of video game execution data according to when the video game execution data was generated. In some examples, the telemetry collection component 210 may include one or more ML models that may perform recognition operations on the rendered outputs of the video game execution data. For example, the telemetry collection component 210 may include an object recognition functionality for recognizing objects in rendered video of the video game execution data. Additionally or alternatively, some or all of the recognition functionality may be performed by the ML model component 204. In some examples, recognized objects in the rendered video may be shown with bounding boxes denoting their location and/or labels. For example, a bounding box may be shown surrounding the object with labels as to the object type and a confidence value for the recognition. Additionally or alternatively, the object recognition data may be included as additional textual data separate from the rendered video. For example, object recognition data may include recognition entries with a bounding box location and extent along with an object type and/or a confidence value for the recognition entry. These and other variations would be apparent to one of ordinary skill in the art.

The telemetry collection component 210 may output the collected and temporally associated video game execution data to the ML model component 204 which may be configured to detect and/or predict the occurrence of events in the video game execution of the game engine component 208.

The ML model component 204 may receive the video game execution data from the telemetry collection component 210. The ML model component 204 may utilize the video game execution data from the telemetry collection component 210 as input to one or more ML model(s) trained to detect and/or predict the occurrence of events in the video game execution of the game engine component 208.

For example, the ML model component 204 may determine events in the video game execution data from rendered video frames of a sports video game and associated textual data generated by instrumented code of the game engine component 208.

FIG. 3 illustrates an example view 300 of a virtual environment in which event detection and/or prediction may be performed based on video game execution data, in accordance with example embodiments of the disclosure.

More particularly, example view 300 is illustrated that shows the rendered video output 302 of a virtual environment of a football video game. In the illustrated example, the rendered video output includes bounding boxes for objects recognized by, for example, the telemetry collection module along with an overlay of various telemetry data.

As illustrated, the rendered video output 302 includes four football player characters. Bounding boxes 304(A)-304(D) have been added by the telemetry collection component 210 to show the location of the character's body. Bounding boxes 306(A)-306 (D) have been added by the telemetry collection component 210 to show the location of the character's helmet. In the illustrated example of FIG. 3, object type and confidence labels are included as textual telemetry data (not shown). However, in other examples, the labels may be included next to the bounding box or in another recognizable matter in the rendered video output. In addition to the players, the rendered video output 302 further includes a bounding box 308 for a field location marking indicative of a distance to a endzone. Of course, the object recognition functionality may recognize many more objects. The number of recognized objects illustrated herein is limited to avoid clutter and confusion.

As mentioned above, the rendered video output may include an overlay with telemetry data. More particularly, the telemetry data includes a frame rate 310, a graph showing processor load 312, a graph showing memory input/output (I/O) load 314, a build number 316 of the game component 202 and a change list identifier 318 of the game component 202.

The ML model component 204 may receive the rendered video output 302 along with other video game execution data. The rendered video output 302 along with the other video game execution data may be input into a ML model of the ML model component 204. The ML model may detect and/or predict events in the videogame execution of the game component 202 based on these inputs. It should be noted that the detection and/or prediction of events may be based on the inputs over time or for each input individually.

For example, in the illustrated football video game example, the ML model component 204 may detect a processor load event including a spike in processor load based on the graph showing processor load 312. The ML model may also recognize that the momentum of play in the football game is moving toward the right boundary while more than 60 yards from the end the zone. The ML model may also recognize that the execution path of the video game execution data at the time of the processor load spike was related to pathing for the football player characters. The ML model may have also been exposed to other scenarios with regard to build number 0100 of the game component 202 and infer that the pathing algorithm, for the football player characters at this position on the field, where three football player characters are moving toward the boundary line at a distance of greater than 60 yards from the end zone, the football player pathing algorithm may experience a runaway loop for each update of the football players' movements which may cause a spike in processing and a drop in frame rate.

In some examples, the ML module component 204 may provide a report of the event via the developer interface component 206. Based on the build number and information about change list for different builds, the ML module component 204 may report that the pathing algorithm issue was already addressed in, for example, build number 0102 (e.g., based on training data or previous scenarios involving build number 0102, the change list for build number 0102, etc.). In some examples, the ML module component 204 may provide an option to update the game component 202 to a newer build (e.g., via a prompt to a user of the game client device 130 or via the developer interface component 206).

In another example, the ML module component 204 may predict that the game component 202 will likely experience a frame rate drop event in the near future based on the rendered video output 302 and the other video game execution data. As mentioned above, a frame rate drop may occur as a result of the GPU processing load rapidly increasing in specific scenarios that occur during gameplay. Different stadiums, weather patterns, ball positions, team matchups or special games may present different scenarios with different loads and code execution paths.

In the illustrated example of FIG. 3, the ML model component 204 may predict a frame rate drop will occur for a next play starting where the four football player characters are positioned based on one or more of a special team matchup type value in the textual data generated by the instrumented code, the object recognition data of the helmets (e.g., bounding boxes 306), the distance marker (e.g., bounding box 308), object recognition identification of the stadium or identification of the stadium in the textual data generated by instrumented code and so on. For example, the team matchup in the illustrated example of FIG. 3 may be an all-star type game of football players from different teams where the players wear the helmet of their respective teams. The object recognition function may determine that the helmets of the players on each team do not match because the team matchup is the all-star matchup. In some examples, having different helmet styles from more than two teams due to the all-star game matchup may increase GPU stress or load. Further, the ML model component 204 may recognize that the next play in the football game will begin more than 60 yards from the endzone. For example, the viewpoint rendered for the player 132 of the video game when the play begins more than 60 yards from the endzone may be a wide shot with a larger number of items to render than the viewpoint rendered for the player 132 when the play begins closer to the endzone (e.g., more spectators, more features of the stadium, more shadows, etc.). As such, the ML model component 204 may infer that when a next play in the game begins, the game component 202 may go into a “high GPU stress” situation based on the special matchup and the play starting from a position far from the end zone (e.g., 60 yards).

The ML model component 204 may provide an output of the prediction of the event via the developer interface component 206, to a player 132 via the game component 202, to the reaction component 212, or so on. For example, where the ML model component 204 predicts that the game component 204 may experience performance issues if played with the current settings for an upcoming play or game, the ML model component 204 may cause the game engine component 208 to display a warning to the player 132 that current configuration will not play well or suggesting that the player 132 modify the rendering settings (e.g. turn off anti-aliasing, reduce shadow quality, reduce rendering detail for the stadium, etc.)

In some examples, the prediction of the event may be utilized by the reaction component 212 to determine a setting change for the game engine component 208 to avoid or ameliorate the event. For example, the reaction component 212 may change the rendering settings to lower a shadow quality, lower detail level of weather, or lower a level of detail (LOD) setting for the game engine component 208. Alternatively or additionally, the ML model component 204 may be configured to output a control to change the rendering settings to lower a shadow quality, lower detail level of weather, or lower a level of detail (LOD) setting for the video game instead or in addition to outputting the prediction of the event to the reaction component 212. For example, the ML model component 204 may output a control to change the rendering settings to the reaction component 212 based on the prediction of the event. More particularly, the ML model component 204 may have been trained based on video game execution data of similar scenarios in which the game engine component 208 was set to use lower rendering settings and during which the predicted event did not occur. Accordingly, the ML model component 204 and/or the reaction component 212 may recommend or cause the game engine component 208 to use the lower rendering setting for the period the ML model component 204 detects or predicts the event for the original rendering settings.

In another example, in the scenario discussed above in which the pathing operations of the football player characters was experiencing a spike in processing load when near the right boundary, the ML model component 204 and/or reaction component 212 may operate to temporarily degrade rendering in favor of gameplay math calculations for navigation or trajectory of the players while in the scenario experiencing the performance issue. In a live gameplay scenario, such operations may provide a feedback loop such that the ML model component 204 may receive video game execution data from the telemetry collection component 210 which was generated when the game engine component 204 was operating based on the settings adjusted by the ML model component 204 or reaction component 212. Additional setting changes may be caused as the effect of the setting changes is reflected in the subsequent video game execution data. Further, the control setting changes may be undone when the ML model component 204 no longer detects or predicts the occurrence of the event under the prior values.

Further, the ML model component 204 and reaction component 212 may operate together to dynamically adjust settings based on detections or predictions of the ML model component 204. For example, the ML model component 204 may determine that the game engine component 208 is unlikely to experience an event with a higher rendering setting than the current setting. As such, the ML model component 204 and/or reaction component 212 may increase the rendering settings until the ML model component 204 detects or predicts an event based on the higher settings.

Further, the ML model component 204 may be utilized to detect or predict the occurrence of events based on fewer inputs than were included in the training data 214. For example, the ML model component 204 may be trained using textual data from instrumented code, results of visual analysis of the rendered video which may include some telemetry data, and/or telemetry data separate from the rendered video. In some examples, the ML model may be utilized to detect or predict the occurrence of events in the video game during an execution of a version or configuration of the video game that does not produce textual data from the instrumented code or include telemetry data in the rendered video. For example, even without one or more of the textual data generated by the instrumented code and/or telemetry data, the ML model may infer the video game is going into a “high GPU stress” situation based on rendered video that shows a next play in the video game will be starting from a position far from the end zone, the weather for the game is snowing, and the lighting conditions will cast complex shadows. In a particular example, the ML model component 204 may be trained and utilized with multiple inputs including the textual data generated by the instrumented code and/or telemetry data overlaid onto the rendered output while in development or testing. The ML model component 204 may also be utilized to detect and/or predict the occurrence of events during normal operation by players 132. More particularly, the instrumented code and/or overlay of telemetry data onto the rendered output may be disabled or removed from a build provided to players for normal operation. In such a case, the ML model component 204 may operate based on the rendered output presented to the players 132 (e.g., via association with the scene displayed). For example, if a video game responds to network disconnects by notifying the user via a message on screen, the ML model component may learn to detect network errors based on the message appearing in the rendered output in addition to the other inputs during development and testing. The ML model component 204 may then detect the occurrence of a network error based on the message appearing in the rendered output with or without the other inputs during operation by players 132.

In addition, the ML model component 204 may learn to predict events with or without the other inputs. For example, the ML model component 204 may learn the factors leading up to a network disconnect, such as user actions or other conditions that would signal an issue may occur in the future. The ML model component 204 may then predict an upcoming network disconnect and/or the user actions or other conditions that would contribute to the event occurring. That information could be reported to the player 132 to allow the player 132 to prepare to lose connection or take action to avoid connection loss or reported back to developers via the developer interface component 206 to allow for the developers to determine a fix.

In some examples, the ML model component 204 may receive control instructions from the developer interface component 206 and/or provide an output to a developer regarding the detection and/or prediction of the occurrence of events in the video game execution of the game engine component 208.

In some examples, the ML model component 204 may include a large language model (LLM) or similar type of ML model capable of performing natural language processing. In some examples, the LLM may be used to produce reports or respond to human queries from a user (e.g., via the developer interface component 206). For example, an LLM may allow for a user to request a report for scenarios in a collection of video game execution data during which the video game experienced high GPU stress. Similarly, the LLM may allow for a user to request an alert when the video game is experiencing or is likely to soon experience high GPU stress during video game execution.

Some other requests could include:
“Show me football games where team X played team Y”
“Show me all games from last night's AI controlled test runs with high GPU load”
“Show me a football game from build X or newer where something interesting happened”
“Create an offensive summary report of all AI controlled test games with Special Matchup Z from Build T”.
“Alert me if you see any online head-to-head games with a low frame rate”

In addition, the LLM may provide for responding to a user request for more detail or clarification regarding a detection or prediction of an event or the operation of the ML model component 204.

Further, an ML model component 204 may be utilized to guide testing of the game engine component 208. As discussed above, the ML model component 204 may be trained to detect CPU stress, GPU stress, network outages and so on from textual data generated by instrumented code, results of visual analysis of the rendered video which may include some telemetry data, and/or telemetry data separate from the rendered video. The ML model component 204 may be configured to predict other scenarios which may be tested to determine if similar GPU stress levels are experienced. Further, a developer may request, via the developer interface component 206, the ML model component 204 generate a set of testing scenarios which may test a different aspect of the video game execution while excluding scenarios that would also cause high GPU stress. For example, the ML model component 204 may receive a request for and generate a set of testing scenarios which would test the video game for high input/output (I/O) stress without high rendering stress (e.g., scenarios where high levels of storage I/O may cause performance to suffer without simultaneous GPU stress). Additionally or alternatively, the ML model component 204 may receive a request for and generate a set of testing scenarios which would test the video game for multiple simultaneous events (e.g., high input/output (I/O) stress, high GPU stress and/or additional types of events) to test the video game performance for “worst case” scenarios.

In some examples, the ML model component 204 may be configured to trigger or modify testing parameters based on detected or predicted occurrences of events. For example, in the above scenario in which the ML model component 204 predicts that the GPU stress is going to increase, possibly resulting in a frame rate drop, the ML model component 204 may operate cause the logging of video game execution data to be increased. For example, the ML model component 204 may be configured to request or instruct the telemetry collection component to increase the rate at which video frames are being captured during the time the all-star game is being played or the period of time that the ball is greater than 60 yards from the end zone.

The models discussed herein may include any models, techniques, and/or machine learned techniques. For example, in some instances, the models may be implemented as a neural network.

An exemplary neural network may be a technique which passes input data through a series of connected layers to produce an output. Each layer in a neural network may also comprise another neural network, or may comprise any number of layers (whether convolutional or not). As can be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, large language models (LLMs), regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

Variations would be apparent based on this disclosure. For example, different event may be detected or predicted for different genres of video games and different examples may utilize the detection or prediction of events for different purposes. Further, additional and/or different information may be provided to the ML model or used in training the ML model. For instance, in addition to build information and change lists for the various builds, some examples may further include providing the source code and/or executable of the build of the video game to the ML model as training or input data.

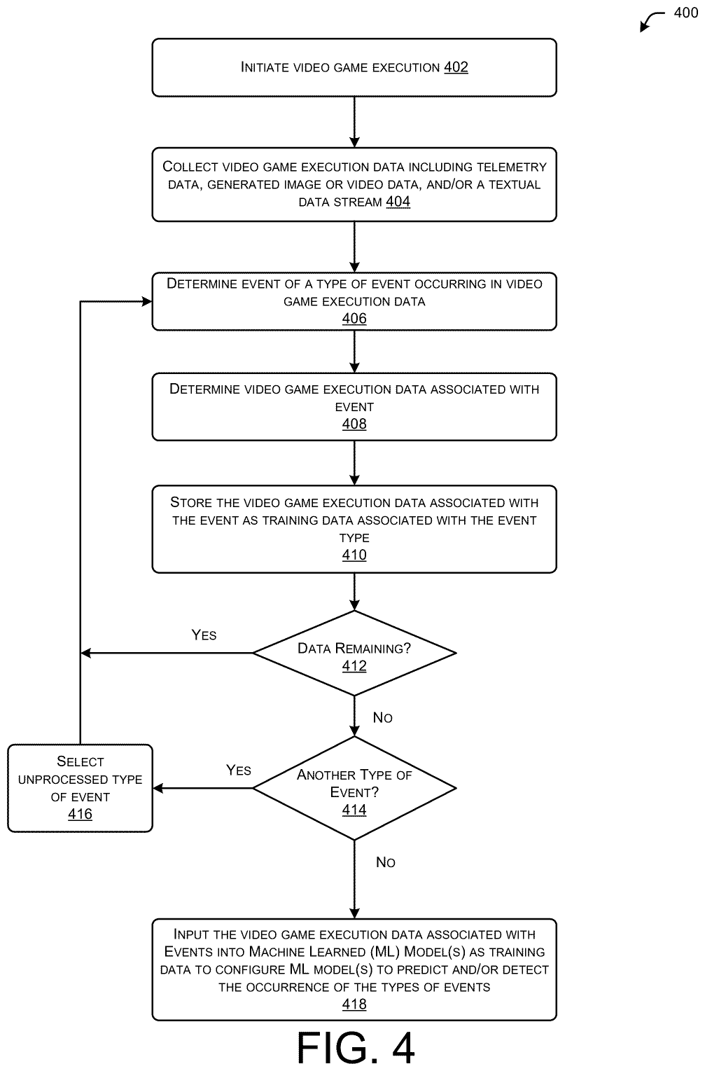

FIG. 4 illustrates a flow diagram of an example method 400 that may train a ML model to detect and/or predict various events in execution of a computer program, in accordance with example embodiments of the disclosure. More particularly, the method 400 may provide for training a ML model to detect and/or predict various events in execution of a game engine. The method 400 may be performed by the devices of the environments 100 and 200. More particularly, the method 400 may relate to the operations of a game system(s) 110 or game client device(s) 130 and may be performed as discussed above.

In 402, a game client device 130 may initiate video game execution. For example, the game component 202 may begin execution of the video game of the game engine component 208.

At 404, the game client device 130 may collect video game execution data including, for example, telemetry data, generated image or video data, and/or a textual data stream. For example, the telemetry collection component 210 may receive the video game execution data from game engine component 208. The telemetry collection component 210 may temporally associate various types of video game execution data according to when the video game execution data was generated. Though not shown, the telemetry collection component 210 may store the collected video game execution data, at least temporarily to a training data store.

At 406, the process may determine an event of a type of event occurring in the video game execution data. Depending on the example, determination of events occurring in training data 214 may be performed based on user input, threshold values or the like. For example, a frame rate drop event may be determined based on a frame rate threshold and a GPU load event may be determined based on a GPU load being over a threshold for a period of time. It should be noted that the examples are not limited to any particular techniques for determining the occurrence of an event in training data. One of ordinary skill in the art would understand how to identify events of various event types to be used in training data in view of this disclosure.

At 408, the process may determine video game execution data associated with event. For example, video game execution data for a range of time surrounding the determined event may be designated as associated with an event of the type of event. For example, video game execution data for 15 seconds before and after a frame rate drop event may be designated as associated with the frame rate drop event type in the training data 214. At 410, the process may include storing the video game execution data associated with the event as training data associated with the event type.

At 412, the process may determine whether video game execution data remains to be checked for events of the current event type. If so, the process may return to 406. Otherwise the process may continue to 414. At 414, the process may determine whether the video game execution data has been checked for all types of event. If a type of event remains to be processed, the process 400 may continue to 416 where an unprocessed type of event may be selected and the process may return to 406 for processing of that event type. If no event type remains to be processed, the process may continue to 418.

At 418, the process may input the video game execution data associated with the events into the ML model(s) as training data to configure the ML model(s) to predict and/or detect the occurrence of the types of events.

Variations would be apparent based on this disclosure. For example, while the training process shown in FIG. 4 is a supervised learning process, examples are not so limited and may include unsupervised learning in addition to or instead of supervised learning.

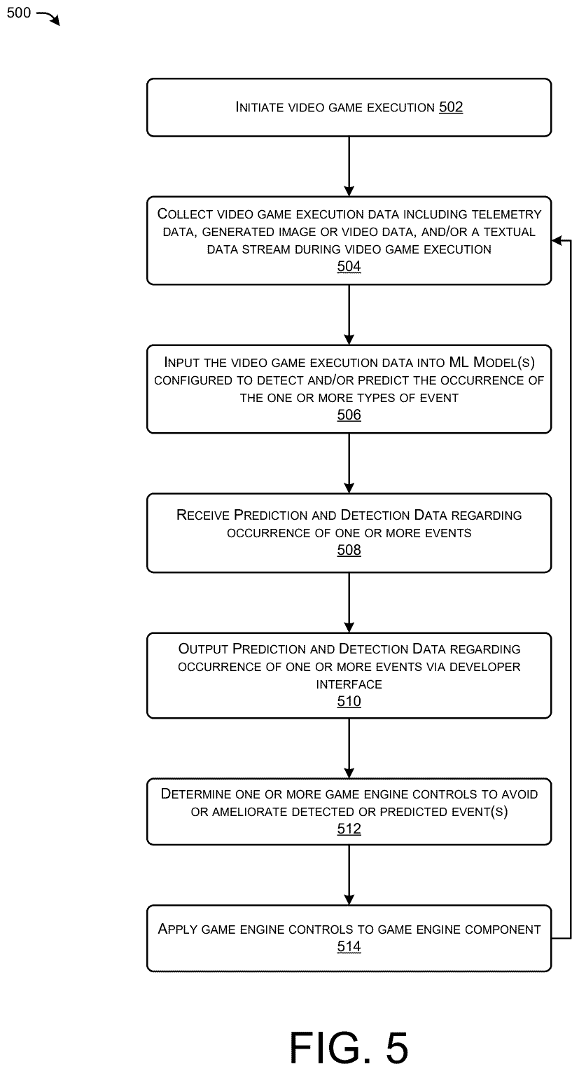

FIG. 5 illustrates a flow diagram of an example method 500 that may provide for detection or prediction of events in execution of a computer program, in accordance with example embodiments of the disclosure. The method 500 may be performed by the devices of the environment 100. More particularly, the method 500 may relate to the operations of a game system(s) 110 or game client device(s) 130 and may be performed as discussed above.

In 502, a game client device 130 may initiate video game execution. For example, the game component 202 may begin execution of the video game of the game engine component 208.

At 504, the telemetry collection component 210 may collect video game execution data including telemetry data, generated rendered outputs (e.g., image or video data), and/or a textual data stream during video game execution.

At 506, the process may include inputting the video game execution data into one or more ML model(s) configured to detect and/or predict the occurrence of one or more types of events. At 508, the process may include receiving prediction and/or detection data regarding the occurrence of one or more events in the video game execution data from the one or more ML model(s).

At 510, the process may include outputting the prediction and/or detection data regarding the occurrence of one or more events via a developer interface. At 512, the process may include determining one or more game engine controls to avoid or ameliorate the detected or predicted event(s). The process may then include applying the game engine controls to the operation of the game engine component at 514. The process may then return to 504 (e.g., while the video game is executing).

It should be noted that some of the operations of methods 400-500 may be performed out of the order presented, with additional elements, and/or without some elements. Some of the operations of methods 400-500 may further take place substantially concurrently and, therefore, may conclude in an order different from the order of operations shown above.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

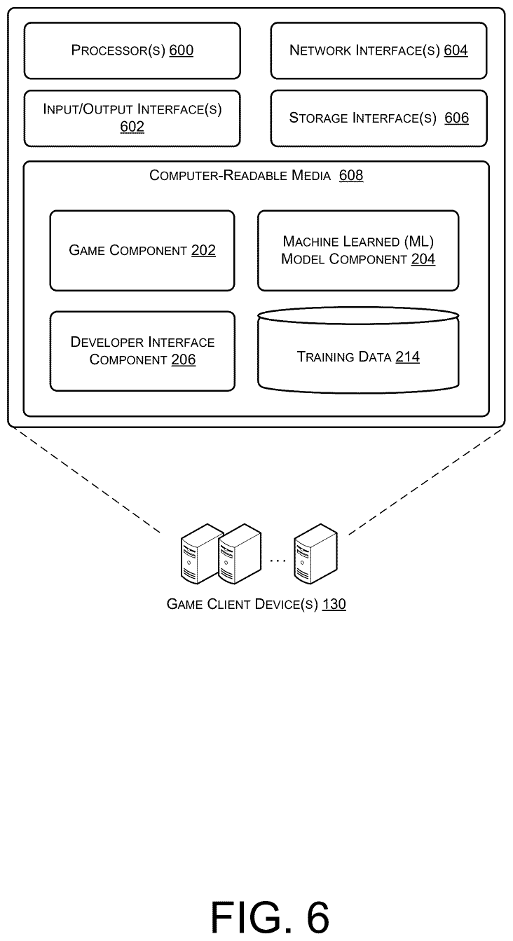

FIG. 6 illustrates a block diagram of example game client device(s) 130 that may provide for detection and/or prediction of various events in execution of a computer program, such as a video game, in accordance with examples of the disclosure. The game client device(s) 130 may include one or more processor(s) 600, one or more input/output (I/O) interface(s) 602, one or more network interface(s) 604, one or more storage interface(s) 606, and computer-readable media 608.

In some implementations, the processor(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 600 may possess its own local memory, which also may store program modules, program data, and/or one or more operating system(s). The one or more processor(s) 600 may include one or more cores.

The one or more input/output (I/O) interface(s) 602 may enable the game client device(s) 130 to detect interaction with a user and/or other system(s), such as one or more game system(s) 110. The I/O interface(s) 602 may include a combination of hardware, software, and/or firmware and may include software drivers for enabling the operation of any variety of I/O device(s) integrated on the game client device 130 or with which the game client device(s) 130 interact, such as displays, microphones, speakers, cameras, switches, and any other variety of sensors, or the like.

The network interface(s) 604 may enable the game client device(s) 130 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of a cellular radio, a wireless (e.g., IEEE 802.1x-based) interface, a Bluetooth® interface, and the like. In some embodiments, the network interface(s) 604 may include radio frequency (RF) circuitry that allows the game client device(s) 130 to transition between various standards. The network interface(s) 604 may further enable the game client device(s) 130 to communicate over circuit-switch domains and/or packet-switch domains.

The storage interface(s) 606 may enable the processor(s) 600 to interface and exchange data with the computer-readable medium 608, as well as any storage device(s) external to the game client device(s) 130.

The computer-readable media 608 may include volatile and/or nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 608 may be implemented as computer-readable storage media (CRSM), which may be any available physical media accessible by the processor(s) 600 to execute instructions stored on the computer readable media 608. In one basic implementation, CRSM may include RAM and Flash memory. In other implementations, CRSM may include, but is not limited to, ROM, EEPROM, or any other tangible medium which can be used to store the desired information and which can be accessed by the processor(s) 600. The computer-readable media 608 may have an operating system (OS) and/or a variety of suitable applications stored thereon. The OS, when executed by the processor(s) 600 may enable management of hardware and/or software resources of the game client device(s) 130.

Several functional blocks having instruction, data stores, and so forth may be stored within the computer-readable media 608 and configured to execute on the processor(s) 600. The computer readable media 608 may have stored thereon a game component 202 that may include a game component 202, a machine learned (ML) model component 204, a developer interface 206, and a training data store 214. It will be appreciated that each of the functional blocks 202-206 and 214 may have instructions stored therein that, when executed by the processor(s) 600, may enable various functions pertaining to the operations of the game client device(s) 130 discussed above.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
one or more processors; and
one or more computer-readable media storing computer-executable instructions that, when executed by the one or more processors, cause the one or more processors to perform operations comprising:
receiving video game execution data of a video game including:
data generated by instrumented code of the video game during execution of the video game;
a rendered output of the video game generated during the execution of the video game; and
telemetry data of the video game generated during the execution of the video game; and
configuring a ML model to at least one of detect or predict a type of events in the execution of the video game using at least the data generated by the instrumented code, the rendered output of the video game, and the telemetry data as training data for the ML model.

2. The system of claim 1, wherein at least a portion of the telemetry data is overlayed into the rendered output.

3. The system of claim 1, wherein the instrumented code includes code for one or more of:
print debugging;
logging; or
tracing.

4. The system of claim 1, wherein the configuring the ML model includes configuring the ML model to output changes to one or more settings of the video game based on at least one of a predicted event of the type of events or a detected event of the type of events in second video game execution data.

5. The system of claim 4, wherein the second video game execution data is output during an execution of the video game and the ML model is configured to output the changes to the one or more settings of the video game during the execution of the video game.

6. The system of claim 1, wherein the type of event is one of:
a frame rate drop;
a processing load above a first threshold;
a pattern in the processing load; a network connectivity loss; or
a storage input/output load above a second threshold.

7. The system of claim 1, wherein the configuring the ML model includes configuring the ML model to output data for an event that is at least one of a predicted event of the type of events or a detected event of the type of events in second video game execution data, the data output by the ML model including at least one of:
a code execution path associated with the event;
a gameplay scenario associated with the event; or
a build or version of the video game in which the event does not occur.

8. The system of claim 1, wherein the configuring the ML model includes configuring the ML model to detect or predict the type of events in the execution of the video game based on second video game execution data of a second execution of the video game not including data generated by at least a portion of the instrumented code of the video game.

9. A computer-implemented method comprising:
receiving video game execution data of a video game including:
data generated by instrumented code of the video game during execution of the video game;
a rendered output of the video game generated during the execution of the video game; and
telemetry data of the video game generated during the execution of the video game; and
configuring a ML model to at least one of detect or predict a type of events in the execution of the video game using at least the data generated by the instrumented code, the rendered output of the video game, and the telemetry data as training data for the ML model.

10. The computer-implemented method of claim 9, wherein at least a portion of the telemetry data is overlayed into the rendered output.

11. The computer-implemented method of claim 9, wherein the instrumented code includes code for one or more of:
print debugging;
logging; or
tracing.

12. The computer-implemented method of claim 9, wherein the configuring the ML model includes configuring the ML model to output changes to one or more settings of the video game based on at least one of a predicted event of the type of events or a detected event of the type of events in second video game execution data.

13. The computer-implemented method of claim 12, wherein the second video game execution data is output during an execution of the video game and the ML model is configured to output the changes to the one or more settings of the video game during the execution of the video game.

14. The computer-implemented method of claim 9, wherein the type of event is one of:
a frame rate drop;
a processing load above a first threshold;
a pattern in the processing load; a network connectivity loss; or
a storage input/output load above a second threshold.

15. One or more computer-readable media storing computer-executable instructions that, when executed by one or more processors, cause the one or more processors to perform operations comprising:
receiving video game execution data of a video game including:
data generated by instrumented code of the video game during an execution of the video game;
a rendered output of the video game generated during the execution of the video game; and
telemetry data of the video game generated during the execution of the video game;
inputting the data generated by the instrumented code, the rendered output of the video game, and the telemetry data into a ML model configured to at least one of detect or predict events of a type of events in the execution of the video game; and
receiving, from the ML model, data associated with an event of the type of events in the execution of the video game.

16. The one or more computer-readable media of claim 15, wherein the data associated with the event includes at least one of:
a code execution path associated with the event;
a gameplay scenario associated with the event; or
a build or version of the video game in which the event does not occur.

17. The one or more computer-readable media of claim 15, wherein the type of event is one of:
a frame rate drop;
a processing load above a first threshold;
a pattern in the processing load;
a network connectivity loss; or
a storage input/output load above a second threshold.

18. The one or more computer-readable media of claim 15, wherein the data associated with the event of the type of events in the execution of the video game includes changes to one or more settings of the video game based on the event.

19. The one or more computer-readable media of claim 18, wherein the event is a predicted event in the execution of the video game, the operations further comprising:
changing the settings of the video game based on the changes to one or more settings of the video game prior to an occurrence of the predicted event.

20. The one or more computer-readable media of claim 15, wherein at least a portion of the telemetry data is overlayed into the rendered output.
